(19) United States
(12) Patent Application Publication
(10) Pub. No.: US 2008/0158642 A1
(43) Pub. Date: Jul. 3, 2008

(54) Liquid crystal display device with electrochromic layer

(75) Inventor: Chih-Yang Hsu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/005,769

(22) Filed: Dec. 27, 2007

(30) Foreign Application Priority Data
Dec. 29, 2006 (TW) 95149703

(51) Int. Cl. G02F 1/153

(52) U.S. Cl. 359/273

(57) ABSTRACT

An exemplary LCD device (2) includes a first substrate (210), a second substrate (220) arranged parallel to the first substrate, a liquid crystal layer (230) interposed between the first and second substrates, and an electrochromic layer (250) with adjustable transmittance and reflectivity. The electrochromic layer is arranged at one surface of the second substrate. The transmittance and reflectivity are adjusted according to environmental brightness.

### FIELD OF THE INVENTION

The present invention relates to liquid crystal display (LCD) devices, and particularly to an LCD device with an electrochromic layer.

### BACKGROUND

Recently, LCDs that are light and thin and have low power consumption characteristics have been widely used in office automation equipment, video units and the like. Among LCD products, there have been the following three types of LCD devices commercially available: a reflection type LCD device utilizing ambient light, a transmission type LCD device utilizing backlight, and a transflective type LCD device equipped with a half mirror and a backlight.

With a reflection type LCD device, a display becomes less visible in a poorly lit environment. In contrast, a display of a transmission type LCD device appears hazy in strong ambient light (e.g., outdoor sunlight). Thus researchers sought to provide an LCD device capable of functioning in both modes so as to yield a satisfactory display in any environment. In due course, a transflective type LCD device was developed.

The transflective type LCD device uses a half mirror instead of the reflective plate used in a reflection type LCD device, and has a minute transmission region (e.g., minute holes in a thin metal film) in a reflection region, thereby providing a display by utilizing transmitted light as well as reflected light. However, the transmission region and the reflection region are fixed when the transflective type LCD device is manufactured. If the environmental light intensity changed, the reflection ratio of the environmental light keeps the same, so that the utilization ratio of environmental light cannot be optimized.

Accordingly, what is needed is an LCD device that can overcome the above-described deficiency.

### SUMMARY

An exemplary LCD device includes a first substrate, a second substrate arranged parallel to the first substrate, a liquid crystal layer interposed between the first and second substrates, and an allochroic layer with adjustable transmittance and reflectivity. The allochroic layer is arranged at one surface of the second substrate. The transmittance and reflectivity is adjusted according to environmental brightness.

Another exemplary LCD device includes a liquid crystal panel, an optical element, an ambient light sensing circuit, and an control circuit. The optical element has adjustable transmittance and reflectivity. The optical element is capable of working in a transmission mode or a reflective mode The ambient light sensing circuit is configured for sensing ambient light signal and conversing the ambient light signal into an electrical signal. The control circuit is configured for receiving the electrical signal and adjusting the transmittance and reflectivity of the optical element according to the electrical signal.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a schematic, side cross-sectional view of part of an LCD device according to a first embodiment of the present invention.

FIG. 2 is a schematic, side cross-sectional view of an electrochromic layer installed in an LC panel of the LCD device of FIG. 1.

FIG. 3 is an abbreviated block diagram of certain parts of the LCD device of FIG. 1.

FIG. 4 is a schematic, side cross-sectional view of part of an LCD device according to a second embodiment of the present invention.

FIG. 5 is a schematic, side cross-sectional view of part of an LCD device according to a third embodiment of the present invention.

### DETAILED DESCRIPTION OF PREFERRED EMBODIMENTS

Reference will now be made to the drawings to describe embodiments of the present invention in detail.

Referring to FIG. 1, this is a schematic, side cross-sectional view of part of an LCD device 2 according to a first embodiment of the present invention. The LCD device 2 includes an LC panel 200 and a backlight module 209 for illuminating the LC panel 200.

The LC panel 200 includes a first substrate 210, a second substrate 220 parallel to the first substrate 210, and an LC layer 230 interposed between the first and second substrates 210, 220. A first polarizer 211 is arranged at an outer surface of the first substrate 210. A color filter 212, a first electrode 214, and a first alignment film 216 are sequentially arranged at an inner surface of the first substrate 210 in that order from top to bottom. A second polarizer 221 is arranged at an outer surface of the second substrate 220. An electrochromic layer 250, an insulating layer 260, a second electrode 222, and a second alignment film 224 are sequentially arranged at an inner surface of the second substrate 220 in that order from bottom to top.

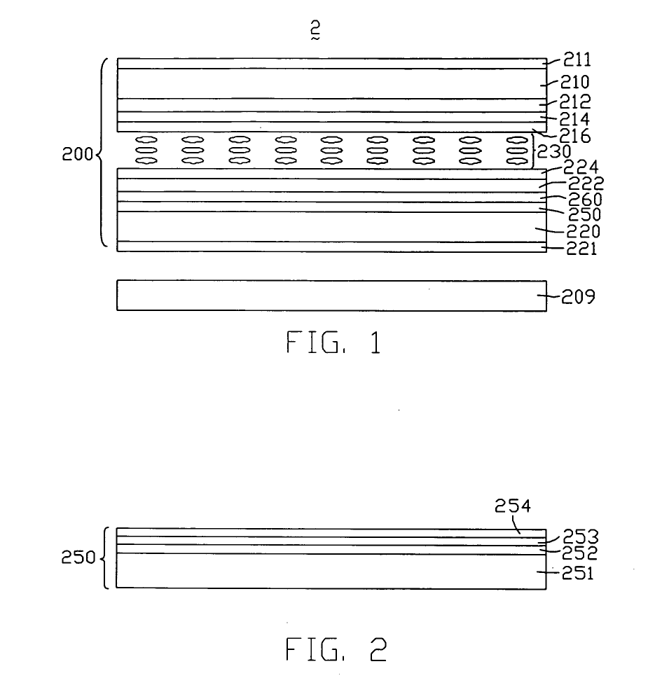

FIG. 2 is a schematic, side cross-sectional view of the electrochromic layer 250 of the LC panel 200. The electrochromic layer 250 has a multilayered structure, which includes a transparent conductive substrate 251, a metal oxide layer 252, an electrolyte layer 253, and a metal layer 254 arranged in that order from bottom to top. The transparent conductive substrate 251 is used for transmitting electrons with negative electricity. The metal layer 254 is used for providing metal ions with positive electricity. The electrolyte layer 253 is used for transmitting the metal ions. The metal oxide layer 252 can for example be made of tungsten oxide (WO₃). The metal layer 254 can for example be made of lithium (Li).

When no voltage is applied between the transparent conductive substrate 251 and the metal layer 254, the electrochromic layer 250 is transparent. Light beams emitted by the backlight module 209 can transmit through the electrochromic layer 250. When a negative voltage is applied between the transparent conductive substrate 251 and the metal layer 254, electrons (e) from an external power supply and the metal ions (Li⁺) from the metal layer 254 are injected into the metal oxide layer 252. Then the electrons and the metal ions occupy lattice vacancies of the WO₃, thereby forming tungsten bronze (Li_{X}WO₃). The Li_{X}WO₃ exhibits bright blue color, and has a high reflectivity and low transmittance. Thus, the electrochromic layer 250 can reflect more light beams. When the negative voltage is reversed, the electrons and the metal ions are detached from the crystal lattices of the Li_{X}WO₃. Accordingly, the Li_{X}WO₃ returns to WO₃. Thus the electrochromic layer 250 returns to transparent. This allows light beams to transmit through the electrochromic layer 250 again.

Accordingly, the electrochromic layer 250 acts as a transflective layer with adjustable transmittance and reflectivity. If the electrochromic layer 250 has a high transmittance, light beams emitted by the backlight module 209 can transmit through the electrochromic layer 250 to illuminate the LC panel 200. If the electrochromic layer 250 has a high reflectivity, the electrochromic layer 250 reflects environmental light beams to illuminate the LC panel 200, while the backlight module 209 is turned off.

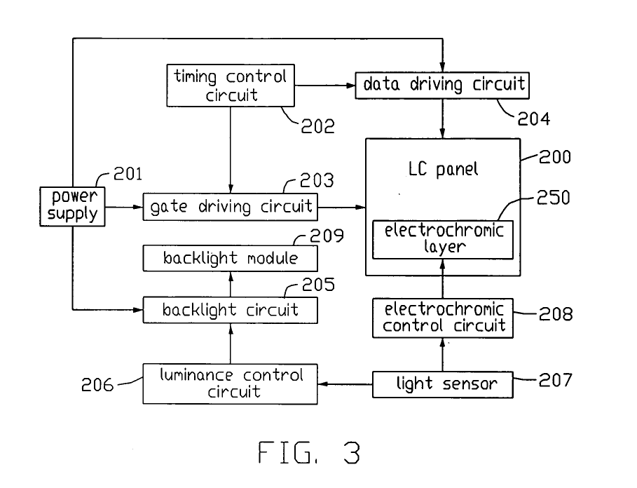

FIG. 3 is an abbreviated block diagram of certain parts of the LCD device 2. The LCD device 2 further includes a power supply 201, a timing control circuit 202, a gate driving circuit 203 connected with the power supply 201 and the timing control circuit 202, a data driving circuit 204 connected with the power supply 201 and the timing control circuit 202, a backlight circuit 205 connected with the power supply 201 to control the backlight module 209, a light sensor 207 for detecting environmental brightness, a luminance control circuit 206 connected with the backlight circuit 205 and the light sensor 207, and an electrochromic control circuit 208 connected with the light sensor 207 and the electrochromic layer 250.

In operation, the light sensor 207 measures an intensity of environmental light and generates an electrical signal corresponding to the intensity of the environmental light. The electrical signal is sent to both the luminance control circuit 206 and the electrochromic control circuit 208. If the environmental light is weak, the luminance control circuit 206 adjusts the backlight circuit 205 to enhance the luminance of the backlight module 209. Simultaneously, the electrochromic control circuit 208 adjusts the electrochromic layer 250 to work in a high transmittance mode, in order to allow more light beams emitted by the backlight module 209 to transmit through the electrochromic layer 250. The LC panel 200 utilizes the light beams to display images. The LCD device 2 works in a transmittance mode.

If the environmental light is strong, the luminance control circuit 206 adjusts the backlight circuit 205 to turn off the backlight module 209. Simultaneously, the electrochromic control circuit 208 adjusts the electrochromic layer 250 to work in a high reflectivity mode, in order to reflect environmental light beams to the LC panel 200. The LC panel 200 utilizes the environmental light beams to display images. The LCD device 2 works in a reflection mode.

And if the environmental light is in a moderate value, the luminance control circuit 206 adjusts the backlight module 209 to emit light beams, and the electrochromic control circuit 208 adjusts the electrochromic layer 250 to work in a mode with suitable transmittance and suitable reflectivity, in order to allow the backlight to transmit through the electrochromic layer 250 and reflect part of the environmental light beams to the LC panel 200. Thus the LC panel 200 utilize both the backlight and the environmental light beams to display images. The LCD device 2 works in a transflective mode.

In summary, the LCD device 2 utilizes the electrochromic layer 250 switching in the high transmittance mode, the high reflectivity, and the transflective mode mode. Thus, The LCD device 2 can work in a reflection mode, a transmission mode and a transflective mode. When the LCD device 2 works in a high brightness environment, the electrochromic layer 250 is adjusted to be with high reflectivity and the backlight module 209 is turned off. Thus, the LCD device 2 can utilize the high reflection ratio of the electrochromic layer 250 to reflect the environmental light for displaying images. When the LCD device 2 is in a low brightness environment, the electrochromic layer 250 is adjusted to be with high transmittance and the backlight module 209 is turned on. Thus, the LCD device 2 utilizes the light beams emitted by the backlight module 209 to display images. Furthermore, when the LCD device 2 is in a moderate brightness environment, the electrochromic layer 250 is adjusted to be with suitable transmittance and suitable reflectivity and the backlight module 209 is turned on. Thus, the LCD device utilizes both the backlight and the environmental beams to display images. Therefore, the LCD device 2 has a higher environmental light utilization ratio and lower power consumption.

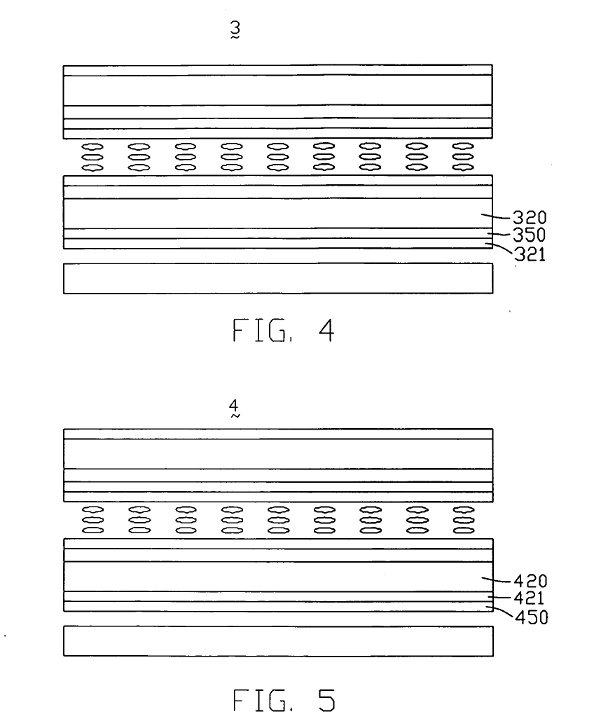

FIG. 4 is a schematic, side cross-sectional view of part of an LCD device 3 according to a second embodiment of the present invention. The LCD device 3 has a structure similar to that of the LCD device 2. However, an electrochromic layer 350 is arranged at an outer surface of a second substrate 320. A second polarizer 321 is arranged at the electrochromic layer 350.

FIG. 5 is a schematic, side cross-sectional view of part of an LCD device 4 according to a third embodiment of the present invention. The LCD device 4 has a structure similar to that of the LCD device 2. However, a second polarizer 421 is arranged at an outer surface of a second substrate 420. An electrochromic layer is arranged at the second polarizer 421.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate arranged parallel to each another;
a liquid crystal layer interposed between the first and second substrates; and
an electrochromic layer with adjustable transmittance and reflectivity;
wherein the electrochromic layer is arranged at one surface of the second substrate, the transmittance and reflectivity are adjusted according to environmental brightness.

2. The liquid crystal display device as claimed in claim 1, wherein the transmittance and reflectivity of the electrochromic layer are adjusted under an electrical voltage.

3. The liquid crystal display device as claimed in claim 2, wherein the electrochromic layer comprises a transparent conductive substrate, a metal oxide layer, an electrolyte layer, and a metal layer arranged in that order from bottom to top.

4. The liquid crystal display device as claimed in claim 3, wherein the metal layer is made of lithium.

5. The liquid crystal display device as claimed in claim 3, wherein the metal oxide layer is made of tungsten oxide.

6. The liquid crystal display device as claimed in claim 1, further comprising a backlight module for illuminating the liquid crystal display device.

7. The liquid crystal display device as claimed in claim 6, further comprising a light sensor configured for sensing environmental brightness signal and converting the environmental brightness signal into a corresponding electrical signal, a luminance control circuit configured for receiving the electrical signal of the light sensor and adjusting a luminance of the backlight module according to the electrical signal, and an electrochromic control circuit configured for receiving the electrical signal of the light sensor and adjusting the transmittance and reflectivity of the electrochromic layer according to the electrical signal.

8. The liquid crystal display device as claimed in claim 7, wherein when the reflectivity of the electrochromic layer increases, the electrochromic layer reflects environmental light for displaying images, when the transmittance of the electrochromic layer increases, the liquid crystal display device utilizes the light beams emitted by the backlight module to display images.

9. The liquid crystal display device as claimed in claim 1, wherein the electrochromic layer is arranged at an inner surface of the second substrate.

10. The liquid crystal display device as claimed in claim 1, wherein the electrochromic layer is arranged at an outer surface of the second substrate.

11. The liquid crystal display device as claimed in claim 10, further comprising a polarizer arranged at the electrochromic layer.

12. A liquid crystal display device, comprising:
a liquid crystal panel,
an optical element with adjustable transmittance and reflectivity, which is capable of working in one of a transmission mode and a reflective mode;
an ambient light sensing circuit configured for sensing ambient light signal and converting the ambient light signal into an electrical signal, and
an control circuit configured for receiving the electrical signal and adjusting the transmittance and reflectivity of the optical element according to the electrical signal.

13. The liquid crystal display device as claimed in claim 12, wherein when the optical element works in a reflective mode, the optical element reflects ambient light beams to illuminate the liquid crystal panel for displaying images.

14. The liquid crystal display device as claimed in claim 12, wherein the optical element is further capable of working in a transflective mode.

15. The liquid crystal display device as claimed in claim 12, wherein the optical element is an electrochromic film.

16. The liquid crystal display device as claimed in claim 15, wherein the electrochromic film comprises a transparent conductive substrate, a metal oxide layer, an electrolyte layer, and a metal layer arranged in that order from bottom to top.

17. The liquid crystal display device as claimed in claim 12, further comprising a backlight module configured for illuminating the liquid crystal panel.

18. The liquid crystal display device as claimed in claim 17, further comprising a luminance control circuit configured for receiving the electrical signal of the light sensor and adjusting a luminance of the backlight module according to the electrical signal.
